(19) United States
(12) Patent Application Publication
(10) Pub. No.: US 2007/0058248 A1
(43) Pub. Date: Mar. 15, 2007

(54) Sport view binocular-zoom lens focus system

(76) Inventor: Minh Thanh Nguyen, Regina (CA)

Correspondence Address: Mr. Minh Thanh Nguyen, 541 Dewdney Ave., Regina, SK, S4N 4E9, CA

(21) Appl. No.: 11/148,116

(22) Filed: Sep. 14, 2005

(51) Int. Cl. G02B 23/00

(52) U.S. Cl. 359/407

(57) ABSTRACT

This technological Invention relates to a goggle system which incorporates a motorized focus binocular built into it, which can be used for any given purpose especially one where the user wishes to observe activities from a distance, which provides for hands free operation, save for the remote that will control all adjustments necessary, especially the focus and magnification aspects. This invention has the aim of providing the individuals the farthest seat at the back of the sports arena; the same first class view as the front row spectators, at any event. The wireless remote allows the individual to easily zoom in on any part of the sports area whenever desired. Because of the wearer's ability to constantly view the action through the apparatus, which may also function as an image enhancement device, the apparatus tends to be an extension of the wearer's vision given rise to a new genre of spectators feeling of “being right there”. The innovative design of the product will radically enhance the way sports fans favourably regard faraway seats, previously deemed as “nosebleed” seats. This apparatus eliminates the need for both hands to be involved when viewing a sports event from a distance seat in the coliseum, bleachers, etc. This invention allows the wearers to use their hands for clapping, pointing and feeding of snacks and beverages. Binoculars always seem to be shared. The main advantage of these goggles is to see the entire event with the best of viewing enhancements.

### FIELD OF THE INVENTION

The present invention pertains generally to a new sports view binocular comprising of many features, which include remote focus, zoom with future night vision and camera viewing capabilities.

### BACKGROUND OF THE INVENTION

Most view enhancements consist of binocular type line-up of lens packaged in a heavy clumsy metal or plastic case that tends to take several adjustments for the individual to see a static stationary object some distance away. They tend to require several manual adjustments for the simplest observation. Upon completing these several manual adjustments the individual can then make another manual adjustment to zoom in the desired image.

These previous sight enhancers tend to be very restrictive in their range of view. Another disadvantage is that the individual requires both hands to operate the view enhancement aid. Therefore, the operator will set it down for long periods of time to do other things like, consumer beverages and food, talk to associates and indulge in other distractions.

Another disadvantage that exist with most viewing aids is the fact that the slightest movement of the operator tends to put the object out of focus until more adjustments are made.

The general thinking at sports arenas is that the individual must pay premium prices to get seats where he/she can efficiently see the game.

There are few inefficient view aids offered for solving this problem.

### SUMMARY OF THE INVENTION

It is an object of this invention to provide a goggle system in which both hands may be left free.

It is a further object of this invention to provide a goggle system, which incorporates a motorized focus system, which is controlled by a wireless remote control.

It is a further object of this invention to provide a range of zoom capabilities of more than 500 metres of magnification features, which is controlled by same wireless remote control.

What is described is a motorized focus binocular formed into a goggle configuration. This wireless remote goggle can effortlessly be worn by the individual for the entire sports event, allowing total concentration by the individual on the event save for monetary breaks to replenish his snack and beverage containers.

The future features to be added to this view enhancement system are: auto focus, built in digital camera, various magnification ranges, night vision and anti-fog heaters (air ventilation now).

### BRIEF DESCRIPTIONS OF THE DRAWINGS

FIG. 1 is a top schematic view of the present invention

FIG. 2 is a front view of the present invention

FIG. 3 is a view of the remote control

FIG. 4 is a side view of the invention

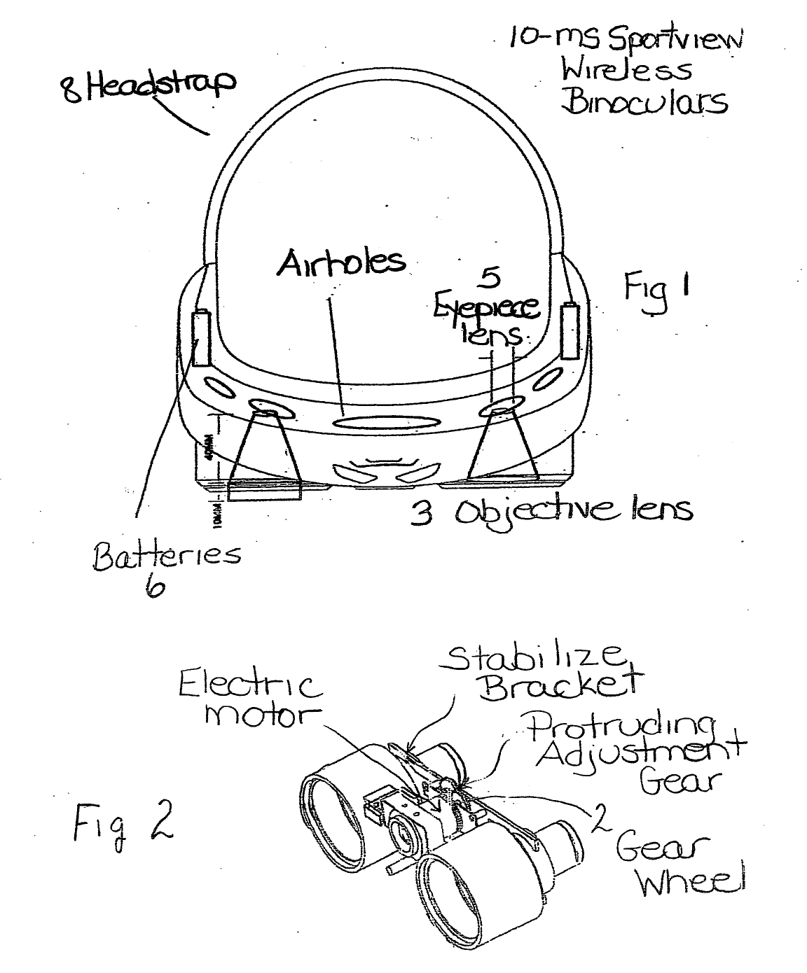

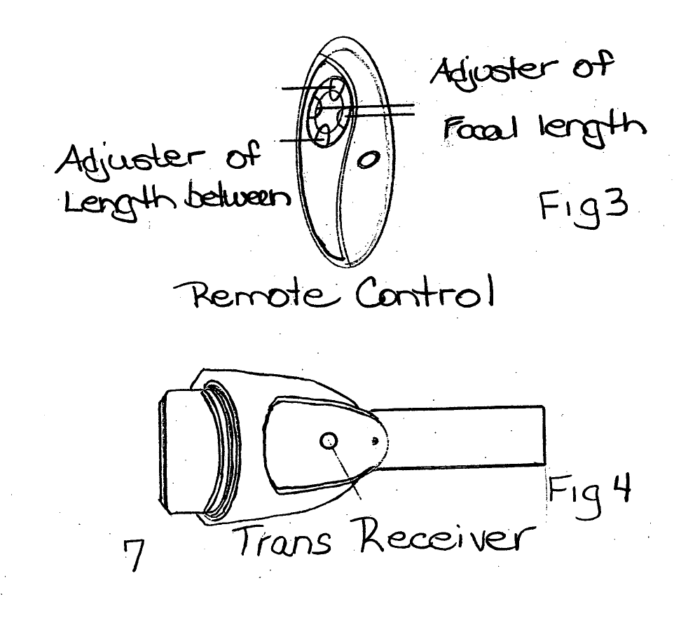

### DETAILED DESCRIPTION OF THE PREFERRED EMBODIMENTS

While the invention shall now be described with reference to the preferred embodiments shown in the drawings, it should be understood that this tendency is not to limit the invention only to the particular embodiments shown but rather to cover all changes, modifications and equivalent arrangements possible within the scope of the appended claims.

The automatic motorized remote controlled wireless binoculars of this invention is referred to generally by the reference numeral 10.

In all aspects of the present invention, references to “sport view Binocular” mean any mechanism or collection of mechanisms able to simultaneously focus and magnify a desired image and transferring the clear image into the retina of the eye of the beholder in a hands-free environment.

With respect to goggles and binoculars, as broadly defined above, the term “zoom” shall be utilized in a broad sense, to mean any pair of lens of different focal length, any mechanism of adjustable magnification or any electronic means of achieving a change in magnification.

References to “transceiver” shall include all combinations of radio transmitters and receivers connected to each other by means of wireless technology including analog or digital transmission and reception of audio signals on different frequencies.

FIG. 1 shows an embodiment of the invention built into goggle frames (10), typically containing a pair of 2 lens assemblies for each eye. The right and left objective lens (3) is located at the extreme front of the binocular assembly (10). These objective lenses (2) gather the light and focus an image of the object inside the goggle. The rear lenses called the eyepiece lens (5) enlarge this image and present it to the eye.

The eye relief of the eye-piece lens (5), which is how far back the eye can be from the eye-piece and still see the entire picture, will have to be from 14 to 20 mm in order to accommodate their eyeglasses.

Ultra thin coatings will be incorporated on the lens surfaces (3) and (5), in order to reduce reflections to retain the 50% of the light that otherwise would be lost to the many glass surfaces inside the goggle assembly (10).

The field-of-view, which refers to the horizontal width of the image, would be designed to the maximum to get the best width of view at the maximum distance.

The zoom function of the Automatic motorized remote controlled wireless binoculars consists of: a motor (1), worm gear (2), objective lenses (3), battery (6) and wireless remote transceiver (7).

The motor (1) consists of very low-voltage 1.5 volt for power. This motor (1) is a stepper motor, that will rotate clockwise and counter-clockwise at very slow, short intervals; to allow for easier and precise zoom function. The batteries (6) are housed in the left and right side panel of the goggle (10) FIG. 1, in the battery compartment (6). This battery function will contain a rechargeable option.

The worm gear mechanism (2) is designed with Teflon plastic gears, which are resistant to dirt and sand and condensation of water. These gears are designed with the precise size for maximum performance desired for a precision focus operation. The worm gear (2) rotates clockwise or counter-clockwise, determined by the message sent from the transceiver (7); depending on which direction the objective lenses (3) need to adjust for proper zoom requirements, summoned by the operator.

The wireless remote control transceiver (7) will incorporate a wireless transmitter and receiver into the wireless remote controlled Binoculars (10). This control (7) will control the main features of motorized precise control of focus and magnification. This control (7) will also control the future options of auto focus, built in digital camera, night vision, and anti-fog heater.

This wireless remote controlled Binocular assembly (10) contains the head strap (8), which holds the assembly firmly on the head. It is adjustable to all sizes.

This apparatus eliminates the need for both hands to be involved when viewing a sports event from a distance seat in the coliseum, bleachers etc.

This invention allows the wearers to use their hands for clapping, pointing and feeding of snacks and beverages. Binoculars always seem to be shared. The main advantage of these goggles is to see the entire event with the best of viewing enhancements.

1) Headgear having a motorized focus binocular borne by said headgear and an adjustable width and depth option borne by said headgear, said electronic lens adjustment responsive to a desired output command by a wireless technology wherein the improvement comprises a totally hands free, light, compact, practical view enhancement aid.

2) The headgear according to claim 1, wherein the air holes incorporated around the lens areas significantly demote the lens fogging in our extreme changing moisture conditions.

3) The headgear according to claim 1, wherein the motorized adjustable focus and zoom lens features are individually controlled by the clock and counter-clock winding features of the wireless controlled motor along with said gear assemblies.

4) The headgear according to claim 1, wherein the gear assemblies adjust for maximum zoom capabilities possible on the eyepiece lens, which in turn the same gear assemblies extend the objective lens 15 mm further, for even more zoom capability

5) The headgear according to claim 1, wherein the width of the lens assembly is controlled by the protruding adjustment gear and associated gear assemblies.

6) The headgear according to claim 1, wherein the stabilizing bracket keeps all assemblies solidly assembled, but is slotted to allow for the adjustment of the eyepiece lens from 60 mm to 70 mm.
